(19) United States
(12) Patent Application Publication
(10) Pub. No.: US 2018/0311830 A1
(43) Pub. Date: Nov. 1, 2018

(54) NEEDLE GRAB

(71) Applicant: ALBRECHT BAEUMER GmbH & CO. KG, Freudenberg (DE)

(72) Inventor: Philip BERTELMANN, Siegen (DE)

(21) Appl. No.: 15/965,935

(22) Filed: Apr. 29, 2018

(30) Foreign Application Priority Data
Apr. 28, 2017 (DE) 102017109155.6
Jun. 8, 2017 (DE) 102017209661.6

(51) Int. Cl. B25J 15/00; B65H 3/22; F16H 19/04

(52) U.S. Cl. CPC B25J 15/0071; B65H 3/22; B65H 2511/222; B65H 2405/60; F16H 19/04

(57) ABSTRACT

A needle grab for handling workpieces has a bar-shaped longitudinally elongated housing having a longitudinally extending face and first and second longitudinally spaced guides defining respective first and second transverse directions that cross each other. First and second holders are transversely slidable in the first and second guides in the respective directions and carry respective first and second sets of at least three first and second grab needles movable with the respective holders relative to the face between a release position recessed behind the face and a gripping position projecting from the face in the first and second directions. A single servomotor is mounted on the housing and is connected via a gear train to both of the holders for synchronously moving same to displace the first and second sets of needles synchronously in the respective first and second directions.

### FIELD OF THE INVENTION

The present invention relates to a needle grab. More particularly this invention concerns such a grab used to pick up a foam-plastic object.

### BACKGROUND OF THE INVENTION

The invention relates to a needle grab for handling workpieces, in particular foam slabs, comprising a grab housing having a face, and a plurality of grab needles movable relative to the face between a release position and a gripping position.

A first set of grab needles is arranged and displaceable in a first alignment and a second set of grab needles is arranged and displaceable in a second alignment having an angle deviating from the first alignment. These the grab needles project out of the face in the extended state and penetrate into the workpiece to grasp it and also are retracted into the face in the retracted state to release the workpiece.

Such needle grabs are used in particular to grasp large-format fabric, foam slabs, fiber materials, fiber composite materials, or other materials which can be penetrated by needles.

Needle grabs are also used in particular to lift such workpieces one by one or layer by layer from a workpiece stack.

A needle grab and a plurality of needle grabs set in a composite are known from DE 10 2014 219 719. Here, three needle grabs are all mounted on a frame and can therefore each be moved jointly. The needle grabs have a base on which slides are attached so they are movable in a straight line by pistons. These slides each have a needle holder on which the grab needles of the needle grab are fastened at their inner ends. Their outer end extend along guide passages of a needle guide block as the main component of a needle guide. The grab needles can move from a retracted position thereof into an extended position by pneumatic movement of the slides of the needle grab. In the extended position they penetrate into the workpiece in the different alignment thereof and thus grasp it.

A needle grab comprising a gripping assembly is described in U.S. Pat. No. 9,758,323. It has a face turned toward the workpiece to be gripped and at least one needle slide carrying at least one gripping needle. The at least one needle slide is movable from a passive position in which the gripping needle is retracted into an active position in which the gripping needle is extended beyond the face by a distance equal to the needle stroke. The needle grab is furthermore provided with a pneumatically or electrically driven drive having an actuator movable forward and backward along a drive direction to displace the needle between the passive and active positions. The needle stroke can be adjusted by a device having a guide slide displaceable perpendicularly to the drive direction along a guide direction and a stop for the guide slide. The actuator is joined by a connecting arm to the guide slide such that, upon retraction of the drive actuator, this guide slide is moved toward the stop and further retraction of the drive actuator is blocked. DE 20 2011 110 569 discloses an electrically driven device for gripping workpieces by a plurality of needles of which only a small number are drivable via a slotted link drive. To be able to grip larger objects, a plurality of such devices have to be arranged in parallel.

The known needle gripping systems require a large number of individual grippers, which are then in turn to be assembled, installed, and aligned with very high expenditure to grasp large foam slabs. Pneumatically operating needle grabs typically have only one piercing length. In pneumatic applications, two piercing lengths would be possible, for example, by a combination of two pneumatic cylinders, but would be very complex.

### OBJECTS OF THE INVENTION

It is therefore an object of the present invention to provide an improved needle grab.

Another object is the provision of such an improved needle grab that overcomes the above-given disadvantages, in particular that can handle large-area foam slabs of different thicknesses in a simple manner and then in turn join them in a precisely fitted manner, for example, to form a mattress.

### SUMMARY OF THE INVENTION

A needle grab for handling workpieces by grab needles has according to the invention a bar-shaped longitudinally elongated housing having a longitudinally extending face, and first and second longitudinally spaced guides defining respective first and second transverse directions that cross each other. A first holder is transversely slidable in the first guide in the first direction and carries a first set of at least three first grab needles movable with the first holder relative to the face between a respective release position recessed behind the face and a respective gripping position projecting from the face in the first direction. Similarly, a second holder is transversely slidable in the second guide in the second direction transverse to the first direction and carries a second set of at least three second grab needles displaceable with the second holder relative to the face between a respective release position recessed behind the face and a respective gripping position projecting from the face in the second direction. A single servomotor is mounted on the housing and is connected via a gear train to both of the holders for synchronously moving same to displace the first and second sets of needles synchronously in the respective first and second directions.

The invention is therefore a simply constructed and easily operated needle grab having a variable piercing depth of the grab needles. It is capable of gripping even greater loads, and a plurality of such needle grabs can be used to form an even larger gripper capable of carrying even heavier loads.

It is advantageous if the longitudinal length of the housing is at least twice as large, preferably at least three times as large, most preferably at least seven times as large as its width. Even large block of foam, may thus be grasped. If the foam also is long, a plurality of needle grabs according to the invention can be applied simultaneously.

It has proven to be advantageous if the housing has a housing upper wall, a lower wall forming the face, longitudinally extending side walls of the housing, and a drive-side first end wall and a second end wall longitudinally closing the house.

It is advantageous that the gear train is a rack-and-pinion gear.

It is advantageous that the each of needle holders is provided with a respective toothed rack meshing with output gears of the gear train.

The guide systems can advantageously have guides fastened in the side walls of the housing connecting the two end walls, and the needle holders are guide carriages slidable in the guides.

It is advantageous according to the invention to limit the stroke of the needle holder using the guide carriages in the guides with a fixed stop is attached to the longitudinal housing. This limits the synchronous extension or retraction in the release position of the needle holders.

A plurality of needle grabs can advantageously be arranged in succession and/or adjacent to one another in a needle grab system, wherein they can be fastened on a common frame or support.

It is noteworthy if at least one needle grab is attached to a robot arm or linear gantry.

### BRIEF DESCRIPTION OF THE DRAWING

The above and other objects, features, and advantages will become more readily apparent from the following description, reference being made to the accompanying drawing in which:

FIG. 1 is a perspective view from above of a needle grab according to the invention; and

FIG. 2 is a section taken along line II-II of FIG. 1.

### SPECIFIC DESCRIPTION OF THE INVENTION

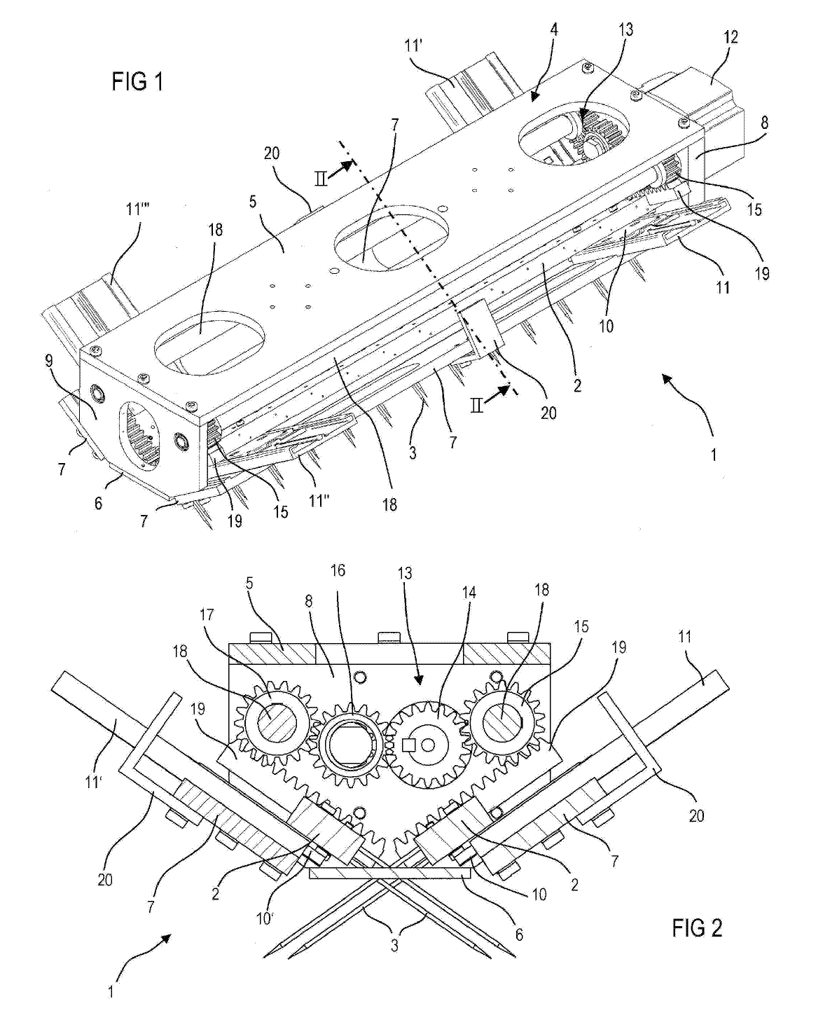

FIG. 1 shows a bar-shaped needle grab 1 for grasping and handling soft deformable workpieces, in particular foam slabs or blocks, by a plurality of grab needles 3 attached to two needle holders 2 in a housing 4. The housing 4 has a housing upper wall 5, a face 6 on the housing lower wall, longitudinal connecting side walls 7, a drive-side end wall 8, and a second end wall 9 closing the housing with the wall 8.

The needle holders 2 are arranged such that the grab needles 3 are aligned at an angle of 90° or more, for example, 110°, to one another and project in the illustrated extended position out of the face 6, as can be seen in particular from FIG. 2 and as described in greater detail below. The needle holders 2 slide by guide carriages 10 and 10′ in guides 11 and 11′ secured to the longitudinal side walls 7 of the housing 4 connecting the two end walls 8 and 9.

A variable drive 12 consisting of a servomotor or a servomotor-transmission combination is operationally connected to a gear train 13 and is attached to the drive-side end wall 8. The gear train 13, which is attached on the inner side of the drive-side end wall 8 and is shown in greater detail in FIG. 2, has a drive pinion 14 connected to the drive axis of the servo drive 12 as a driving gear. This drive pinion 14 acts directly on a first output gear 15 and via an intermediate gear 16, which reverses the rotational direction, on a second output gear 17.

The output gears 15 and 17 are connected by shafts 18 for synchronization to two further output gears 15 and 17 arranged and mounted so they are rotatable on the second end wall 9. The gears 15 and 17 engage in toothed racks 19 attached to the needle holders 2 and facing toward the end walls 8 and 9.

As shown in FIG. 2, the grab needles 3 are located in the active or gripping position, i.e. they project far out of the face 6 and can penetrate into a workpiece immediately below or against the face 6 in order to grab it. The face 6 is used in the lower position of the needle holders 2 as an end stop, so that movement of the needle holders 2 out of the linear guides 11 and 11′ is prevented. Furthermore, the face 6 is used as a stop to reference the drives, i.e. to determine and establish the position of the grab needles 3 for a controller of the grab 1. The piercing depth into the workpiece to be gripped is dependent in this case on its thickness and is ensured by appropriate activation of the servo drive 12.

Due to this activation of the servo drive 12 attached to the drive-side end wall 8, the needle holders 2 may be moved up and down synchronously with the respective guide carriages 10 in the respective guides 11. The grab needles 3 attached to the needle holders 2 can therefore be moved from the active or gripping position shown in FIG. 2 into a passive or release position in which the grab needles 3 are all withdrawn behind the face 6. For this purpose, the servo drive 12 rotates the drive pinion 14 clockwise, whereupon the first output gear 15 rotates counterclockwise. The toothed rack 19 is thus moved upward, and therefore the needle holders 2, grab needles 3, and guide carriages 10 connected thereto move together into the release position. At the same time, the shaft 18 transmits the movement to an output gear 15 on the second end wall 9, which assists the movement and ensures that the needle holder 2 does not bend or warp. A fixed stop 20 limits the synchronous extension or retraction into the release position of the needle holders 2 with the guide carriages 10 in the guides 11.

On the other side, the intermediate gear 16 is rotated counterclockwise by rotation of the drive pinion 14 clockwise so that the second output gear 15 in turn moves clockwise. The respective toothed rack 19 is thus also moved upward, and therefore the needle holders 2, grab needles 3, and guide carriages 10 connected thereto move synchronously into the release position. The intermediate gear 16 is necessary, since otherwise the needles would move oppositely. Movement is also assisted here by a shaft 18 that transmits movement to an output gear 15 arranged on the second end wall 9 as part of a second gear train identical to that shown in FIG. 2.

Soft deformable workpieces may easily be grasped and handled using such a bar-shaped needle grab 1. Thus, large-area foam slabs can be grasped, and can then in turn be joined in a precisely fitted manner to for example form a mattress. If larger or heavier workpieces are to be processed, a plurality of bar-shaped needle grabs 1 can be fastened on a frame in a simple manner and used as needle grab systems or so-called needle grab gantries or linear gantries. However, they can also be mounted on robots, to transport the foam slabs to the respective assigned destination.

The advantage of these needle grab bars 1 is the movement of many grab needles 3 on two needle holders 2 or bars using only one servo drive 12. In this case, the grab needles 3 are inserted crosswise into the foam, in order to fix the foam slabs. The drive power of a servo drive 12 and the distribution thereof are actuated via the gears 14 to 17 of the gear train 13 and shafts 18 for synchronization. Relative to pneumatic solutions, the piercing depth can be set free of a higher-order controller in accordance with the slab thicknesses to be grasped. Two or more slabs are therefore prevented from being received simultaneously.

In summary, foam slabs may be grasped in a large area in a simple manner by the present bar-shaped design according to the invention of the needle grabs 1. Furthermore, the bar-shaped needle grabs 1 may be assembled very easily into larger grippers. Thus, for example, nine needle grab bars can also be assembled according to the invention into an overall gripper moved by linear gantries or robots using the housing lower walls of the nine needle grab bars onto the foam slab to be grasped. Using the servo drive 12, the gear train 13, and the gear drive on the right and left having two toothed racks 19 in each case per needle holder 2 having gripper needles 3, these needles are pierced into the foam slab. The piercing depth is dependent on the slab thickness to be grasped and is ensured by appropriate activation of the servo drive 12.

After receiving the foam slab and placing it on the predefined placement space, the grab needles 3 are withdrawn from the foam slab again with the aid of the two needle holders 2. The faces 6 of the housing lower walls of the needle grabs 1 are used in this case as counter holders, so that the grab needles 3, without raising the foam slab again, can be withdrawn therefrom.

I claim:

1. A needle grab for handling workpieces, the grab comprising:
a bar-shaped longitudinally elongated housing having a longitudinally extending face, and first and second longitudinally spaced guides defining respective first and second transverse directions that cross each other;
a first holder transversely slidable in the first guide in the first direction;
a first set of at least three first grab needles fixed in the first holder and movable therewith relative to the face between a respective release position recessed behind the face and a respective gripping position projecting from the face in the first direction;
a second holder transversely slidable in the second guide in the second direction transverse to the first direction;
a second set of at least three second grab needles fixed in the second holder, displaceable therewith relative to the face between a respective release position recessed behind the face and a respective gripping position projecting from the face in the second direction;
a single servomotor mounted on the housing; and
means coupling the servomotor to both of the holders for synchronously moving same to displace the first and second sets of needles synchronously in the respective first and second directions.

2. The needle grab defined in claim 1, wherein a transverse width of the housing is at least two times as great as a longitudinal length of the housing.

3. The needle grab defined in claim 1, wherein the housing has and upper wall, a lower wall forming the face, two transversely spaced side walls, and two longitudinally spaced end walls, the upper, lower, and side walls all extending longitudinally between the end walls, one of the end walls carrying the servomotor and transmission means.

4. The needle grab defined in claim 3, wherein the transmission means is a gear train on the connected between the servomotor and the first and second holders.

5. The needle grab defined in claim 4, wherein each of the holders is provided with a rack extending in the respective direction and meshing with the gear train.

6. The needle grab defined in claim 3, wherein each of the guides is carried on a respective one of the end walls.

7. The needle grab defined in claim 1, further comprising:
respective first and second stops fixed to the housing and limiting displacement of the respective first and second holders in the first and second directions.

8. The needle grab defined in claim 1, wherein a plurality of the needle grabs are mounted on a common support extending longitudinally parallel to each other.

9. The needle grab defined in claim 8, wherein the support is a robot arm or gantry.

10. The needle grab defined in claim 1, wherein the first needles and second needles lie in respective first and second planes that cross each other at an acute angle.

11. The needle grab defined in claim 10, wherein the first and second needles engage between each other when moving between the release position and the gripping position.

12. The needle grab defined in claim 1, wherein in the gripping position each of the needles forms an acute angle with the face.
